(19) United States
(12) Patent Application Publication
(10) Pub. No.: US 2019/0035248 A1
(43) Pub. Date: Jan. 31, 2019

(54) REMOTE COMMUNICATION SYSTEM

(71) Applicant: KUTTA RADIOS, INC., Phoenix, AZ (US)

(72) Inventors: Patrick A. MURPHY, Phoenix, AZ (US); Matthew James SAVOCA, Glendale, AZ (US); Geoffrey D. SIMMS, Phoenix, AZ (US)

(73) Assignee: KUTTA RADIOS, INC., Phoenix, AZ (US)

(21) Appl. No.: 16/018,382

(22) Filed: Jun. 26, 2018

Related U.S. Application Data
(60) Provisional application No. 62/537,827, filed on Jul. 27, 2017.

(51) Int. Cl. G08B 21/12; G08B 21/18; G08B 1/08; G08B 3/10

(52) U.S. Cl. CPC G08B 21/12; G08B 3/1033; G08B 1/08; G08B 21/182

(57) ABSTRACT

In one embodiment, an underground communication system is described. The system includes a low to medium frequency transmitter and a plurality of receivers. The transmitter comprises an output coupler and a signal selection unit. The transmitter is operable to generate a low to medium frequency signal. Each of the plurality of receivers includes an antenna and at least one sensory output unit. The plurality of receivers is configured to detect a low to medium frequency signal.

### RELATED APPLICATIONS

This application claims priority to U.S. Provisional Patent Application No. 62/537,827, filed on 27 Jul. 2017 and titled “Remote Communication System,” which application is incorporated herein in its entirety by this reference.

### TECHNICAL FIELD

The present disclosure relates generally to remote alert systems, and more specifically to remote alert systems for confined spaces such as underground environments, and related methods of communicating within such confined spaces.

### BACKGROUND

Mining disasters are well known and, in modern history, fairly well documented. In the 21st century to date, fatalities in mining accidents have reached into the thousands. The causes of mining disasters are diverse. Some causes of mining disasters are explosions, gas leaks, fires, floods, and suffocation. Communicating with personnel located in the mines may prevent numerous fatalities. However, there are many challenges associated with transmitting messages in mines and other underground environments. Signals cannot easily transmit through the earth to reach various people that may be located in a mine.

Previous solutions are unable to fully communicate to all personnel located within a mine. For example, FIG. 11 displays an exemplary mine 1100 which may include one or more passageways 1102 and rooms 1104. The communication system may comprise a first station 1106 located above the surface 1108 and several stations 1110 below the surface. A message may be communicated from the first station 1106 to several stations 1110 below the surface. While this type of system may be capable of communicating an emergency situation, the limited number of personnel whom receive the message are required to disseminate the message to other personnel. In some instances, this manual dissemination of the message may be difficult or impossible. For example, a collapse 1112 may prevent personnel at a station 1110 from being able to distribute the message to trapped personnel 1114 on the other side of the collapse 1112. Therefore, a need exists to develop a new messaging system that can effectively reach all personnel in mines and other underground environments.

### SUMMARY

In one embodiment, an underground communication system is described. The system includes a low to medium frequency transmitter and a plurality of receivers. The transmitter comprises an output coupler and a signal selection unit. The transmitter is operable to generate a low to medium frequency signal. Each of the plurality of receivers includes an antenna and at least one sensory output unit. The plurality of receivers is configured to detect a low to medium frequency signal.

In some embodiment, the transmitter may include an input unit, a microcontroller, a modulator, and an amplifier. In some embodiments, the output coupler may be a magnetic antenna. In another embodiment, the output coupler may be an inductive clamp or a galvanic electrical connection. The wireless receiver antenna may comprise a coil of wire on a ferrite core. In some instances, the transmitter may send a signal through the conductor to the at least one wireless receiver. The signal may be between about 30 kHz and about 300 kHz, between about 300 kHz and about 3 MHz, between about 30 kHz and about 3 MHz, or any range within the range of about 30 kHz and about 3 MHz.

In some embodiments, the transmitter output coupler may be coupled to a conductor positioned beneath a ground surface and the signal may be propagated beneath the ground surface. The signal may propagate under the ground surface through parasitic propagation in man-made metallic items and/or other signal conducting materials. The plurality of receivers may each include an accessory unit, and the accessory unit has a transmitter configured to transmit data which may include a unique identifier for the receiver. In some instances, the at least one sensory output unit may comprise one or more of an audio output, a visual output, or a tactile output. The signal selection unit may comprise a manual signal selection unit. In alternative embodiments, the signal selection unit may comprise an automatic signal selection unit.

In another embodiment, a method of electronic communication in an underground environment is described. The method includes selecting a signal to transmit to at least one receiver located in the underground environment. The method includes transmitting the selected signal as a low to medium frequency signal to the at least one receiver located in the underground environment. The transmitting includes propagating the selected signal through parasitic propagation in man-made metallic items and/or other signal conducting materials located in the underground environment.

In some embodiments, the at least one receiver may include a plurality of receivers. The method may further include parsing the plurality of receivers into at least two groups of receivers and selecting a first signal to send to a first of the at least two groups of receivers. The method may further include selecting a second signal to send to a second of the at least two groups of receivers and transmitting the first and second signals as low to medium frequency signals to the first and second groups of receivers.

In another embodiment, a method for receiving an underground communication is described. The method includes selectively listening for a signal transmission and receiving more than one signal transmission. The method includes filtering the signal transmissions and identifying the appropriate signal transmissions. The method includes deciphering the identified signal transmission and taking one or more predetermined responses based at least in part on the identified signal transmission.

In some embodiments, the method may further include activating one or more sensory output units based at least in part on the deciphered signal transmission. The method may further include taking no action based at least in part on the deciphered signal transmission and resuming selectively listening for a signal transmission. The signal may be a low to medium frequency signal.

In another embodiment, a method to reduce noise in data transmission is described. The method includes receiving one or more signals and parsing a frequency range of the one or more signals. The method includes determining a time length of the parsed frequency signal and implementing one or more predetermined actions based at least in part on the frequency range and signal length. In some embodiments, the method may further include determining if the signal frequency is a fixed frequency deviation low signal or a fixed frequency deviation high signal. The method may further include setting a first predetermined time period to a first data bit and assigning the first data bit to a signal in a first signal frequency for a first predetermined time period. The method may further include setting a second predetermined time period to a second data bit and assigning the second data bit to a signal in a first signal frequency for a first predetermined time period. In some embodiments, the method may further include determining if an incoming transmission is an invalid bit.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 illustrates a schematic of an exemplary underground environment, in accordance with various aspects of this disclosure;

FIG. 2 illustrates a block diagram of an exemplary remote communication system, in accordance with various aspects of this disclosure;

FIG. 3 illustrates a block diagram of an exemplary transmitter, in accordance with various aspects of this disclosure;

FIG. 4 illustrates a block diagram of an exemplary receiver, in accordance with various aspects of this disclosure;

FIG. 5 illustrates a swim diagram relating to a remote communication system, in accordance with various aspects of this disclosure;

FIG. 6 is a flow chart illustrating an example of a method relating to a remote communication system, in accordance with various aspects of this disclosure;

FIG. 7 is another flow chart illustrating an example of a method relating to a remote communication system, in accordance with various aspects of this disclosure;

FIG. 8 is another flow chart illustrating an example of a method relating to a remote communication system, in accordance with various aspects of this disclosure;

FIG. 9 is another flow chart illustrating an example of a method relating to a remote communication system, in accordance with various aspects of this disclosure;

FIG. 10 is another flow chart illustrating an example of a method relating to a remote communication system, in accordance with various aspects of this disclosure;

FIG. 11 illustrates an underground environment with a prior art communication system.

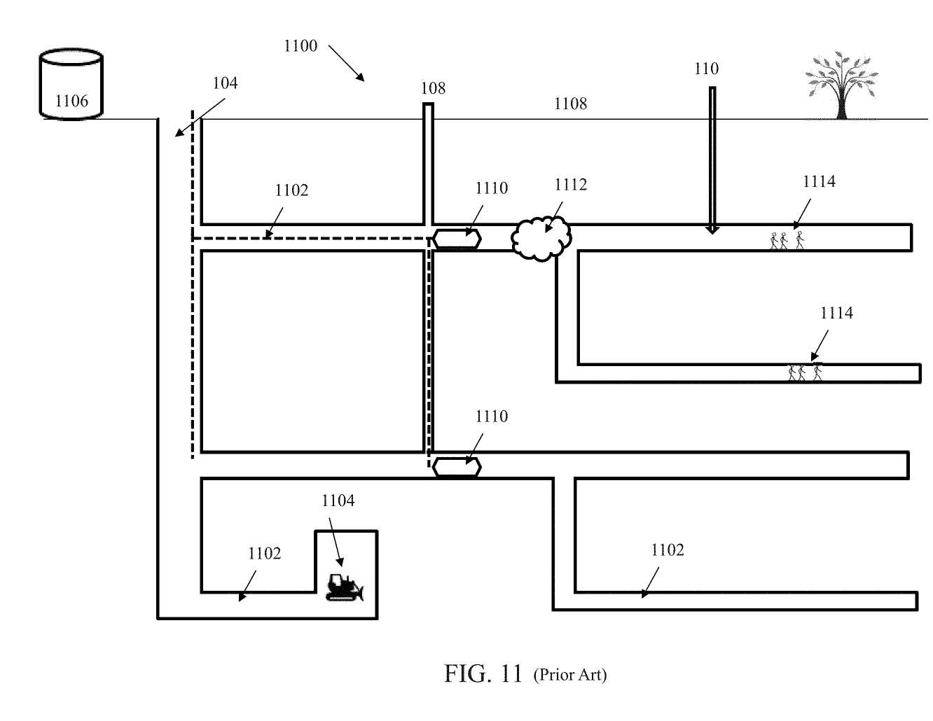

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Transmitting messages to all personnel in mines and other underground environment is difficult. New passageways are continuously being built and establishing communication infrastructure is slow. As personnel enter into various areas, alert systems may not be established. For example, speakers or other alert infrastructure may not have been incorporated or established yet. Therefore, passageways and other areas of an underground environment may not have emergency notification infrastructure. Additionally, a single transmission point relies on personnel themselves to distribute messages to other personnel in case of an emergency. Personnel may therefore fail to receive emergency messages. These messages may be vitally important to their health and well-being. For example, if a fire starts in the underground environment, other personnel may need to exit to prevent suffocation or other severe bodily injury.

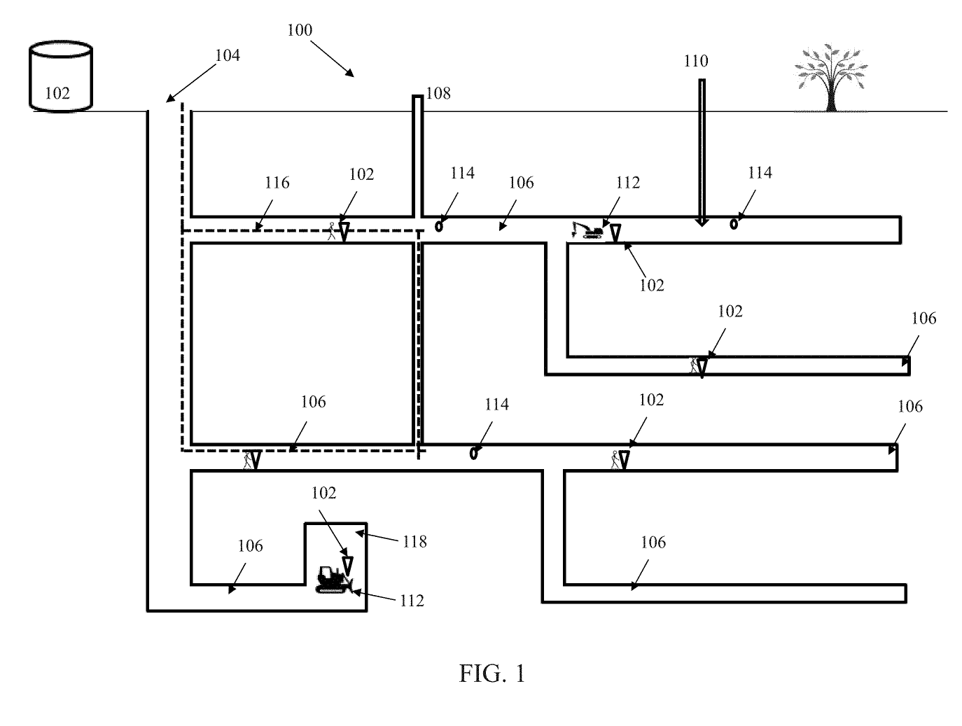

FIG. 1 illustrates an example of an exemplary underground environment 100 which may utilize a remote alert system 102. The underground environment 100 may include one or more entry points 104 and one or more passageways 106. The entry point 104 may enable equipment and personnel to enter or exit the various passageways 106. The passageways 106 may have one or more exhaust vents 108 and air intake 110. Various equipment 112 may be present in the underground environment 100. The equipment may include various trucks, bulldozers, drills, dragline, loaders, graders, etc. Electrically powered devices 114 may be present in the underground environment 100 which may include various wires 116 and electrical equipment. In some embodiments, various “rooms” 118 may be present in the passageways which may include mechanic bays, garages, and various other areas in the underground environment 100. In some embodiments, the underground environment 100 may include a remote alert system 102.

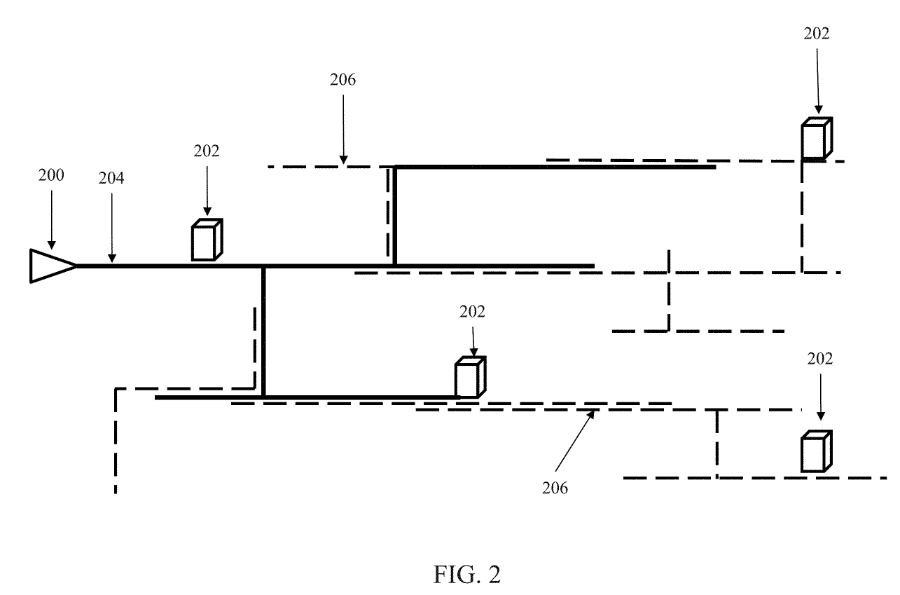

FIG. 2 illustrates a block diagram of a communication system including a remote alert system 102. The remote alert system 102 may include a transmitter 200 and one or more receivers 202. The transmitter 200 may be located on a surface of the ground. The receiver 202 may be handheld equipment which may be capable of receiving a message transmitted by the transmitter 200. The receiver 202 may comprise an enclosed box which may prevent environmental contaminants from affecting its functionality. In additional embodiments, the receiver 202 may be a larger unit which may be stationary. The remote alert system 102 may comprise a plurality of receivers 202. For example, each of the personnel entering the passageways may carry a receiver 202. In some embodiments, the personnel may be subdivided and each receiver 202 may be grouped accordingly. The remote alert system 102 may include an input conductor 204. The remote alert system 102 may also utilize neighboring conductors 206.

The transmitter 200 may emit a signal into the shaft via the input conductor 204. The signal may comprise a low to medium frequency signal. A low frequency range may be approximately 30 kilohertz (kHz) to 300 kHz. A medium frequency range may be approximately 300 kHz to 3 megahertz (MHz). Accordingly, the signal typically is within the range of about 30 kHz to about 3 MHz, or within a subrange that falls within this range. As the signal is distributed along the input conductor, the signal may emanate throughout various passageways (e.g. passageways 106). Due to the frequency of the signal, neighboring conductors 206 may pick up the frequency and continue to distribute it throughout the underground environment. The neighboring conductors 206 may consist of other metallic infrastructure in the underground environment. For example, the neighboring conductors 206 may consist of the equipment (e.g. equipment 112), wires (e.g. wires 116), and other metallic infrastructure and/or other materials and objects that may be present in an underground environment and are capable of conducting and propagating a signal.

In some instances, the signal may propagate through magnetic induction. For example, the oscillating currents which carry the transmitted signal in conductive objects may emanate corresponding oscillating magnetic fields. These oscillating magnetic fields may envelop other conductive objects in proximity and induce corresponding oscillating electric currents in them. By repetition of this process, much of the conductive content in the underground or otherwise enclosed space may carry and emanate the signal. For example, the input conductor 204 may serve as a conduit to initiate the signal into the underground environment. That signal may then travel to other wires 206 and/or metallic objects in the underground environment to traverse through the various passageways.

The receiver 202 may receive the signal from the input conductor 204 or neighboring conductors 206. The receiver 202 may parse the picked-up signal. The receiver 202 may then interpret the signal and determine an action to take. For example, the signal may communicate one of a variety of messages. The messages may consist of an “all-ok” message or a “status-quo” message. For example, there may be no health, safety, or other concerns so the signal may simply transmit a message to indicate everything is normal. The receiver 202 may then display a signal representing or conveying a predetermined action. For example, the receiver 202 may indicate to the personnel that everything is okay. Alternatively, the receiver 202 may take no action and not generate communication to a user.

In some embodiments, the picked-up signal may represent a warning or other message to users. For example, a danger may be present in the underground environment such as a fire, a collapse, a gas leak, a flood, fumes, explosions, or the like. The dangers may additionally or alternatively not be a product of the underground environment but of some other man-made or natural disaster. For example, a weather event may be present at the surface causing a danger in the passageways. In other embodiments, a natural disaster may be occurring such as an earthquake. Still further emergency situations may arise such as a terrorist or other event at the surface above the underground environment. This may result in the need to disseminate a warning and/or instructions to personnel located within and around the underground environment. In some instances, the system may additionally be conducting a test of the alert system.

The warning may consist of communicating the event. For example, the transmitter 200 may have one or more inputs which may enable personnel to disseminate a communication to alert various other personnel of the presence of an event. In some instances, the communication may additionally or alternatively comprise directions or instructions to personnel. There may be instances where the message does not communicate the disaster or event but may simply communicate instructions. Instructions may comprise a plurality of instructions which may include instructions to evacuate, evacuate through a specific entryway, shelter in place, to equip with specific safety equipment, and the like.

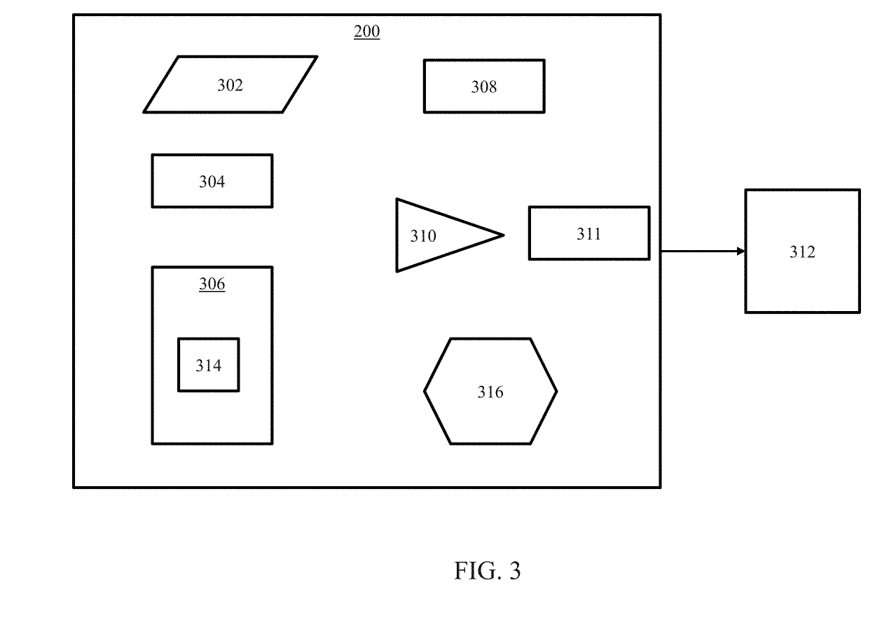

FIG. 3 is a block diagram of a transmitter 200. The transmitter 200 may comprise an input unit 302, a controller 304, memory 306, a modulator 308, an amplifier 310, and an output coupler 311. In some embodiments, the transmitter 200 may comprise additional or fewer components. In still further embodiments, the transmitter 200 may be coupled to a conductor 312. In some embodiments, the memory 306 may include one or more communication module 314. Each of these components may be in communication with each other-directly and/or indirectly.

In some embodiments, the controller 304, and memory 306, the input unit 302, a modulator 308, amplifier 310, output coupler 311, and conductor 312 each may communicate—directly or indirectly—with one another (e.g., via one or more buses not shown). The modulator 308 may modulate signals and provide the modulated signals to the one or more amplifiers 310 for transmission. While the transmitter 200 may be connected to a single conductor 312 through a single output coupler 311, the transmitter 200 may couple to multiple conductors 312 through multiple output couplers 311 capable of concurrently transmitting multiple transmissions. In some embodiments, one element of the transmitter 200 may provide a direct connection to a remote server (not shown) and/or other computers (not shown) via a direct network link. In some embodiments, one element of the transmitter 200 may additionally connect to the Internet via a POP (point of presence). In some embodiments, one element of transmitter 200 may provide a connection using wireless techniques, including digital cellular telephone connection, Cellular Digital Packet Data (CDPD) connection, digital satellite data connection, and/or another connection.

The input unit 302 may comprise a plurality of input devices. For example, the input unit 302 may consist of a manual input such as a knob or buttons or a tactile input mechanism to determine which message to disseminate. In other embodiments, the input unit 302 may consist of a graphical user interface wherein a user may input a message using a touch screen, mouse, keyboard or other computer related device to disseminate the desired message.

In still further embodiments, the input unit 302 may be automated. For example, the input unit 302 may be programmed such that a message will be automatically disseminated when the transmitter 200 detects and/or receives notification of a safety event. For example, various alarms, sensors, and/or other data gathering equipment may be present in and around the underground environment. When the data gathering equipment detects a safety hazard, the transmitter 200 may automatically disseminate an appropriate message. In some instances, the transmitter 200 may additionally and/or alternatively be connected to various input devices throughout the underground environment. For example, the transmitter may have a wired or wireless connection to a device that may enable personnel to manually input a safety event. The transmitter 200 may then, using one or more algorithms, determine which safety message to disseminate based on the received information.

In some instances, the transmitter 200 may operate as either an automated system or a manual system. In still further embodiments, the transmitter 200 may be both an automated and a manual system. For example, the transmitter 200 may be set to automatically distribute messages based on input detected but the automated system may be overridden to enter a manual message as required. The transmitter 200 may be easily switched into the two modes. In still further embodiments, the transmitter 200 may require entry of a passcode or other authentication message prior to either switching modes or disseminating a manual message.

The controller 304 may comprise a chip, expansion card, or stand-alone device. The controller 304 may interface with a peripheral device. For example, the controller may link two various parts of the transmitter 200. In some instances, the controller 304 may be a microcontroller. In some embodiments, the controller 304 may comprise a processor and/or microprocessor. In some embodiments, the modulator 308 may be located within the processor. In other embodiments, the modulator 308 may be separate from the controller 304 but may connect to the controller 304 via one or more buses. The controller 304 may connect to memory 306.

The memory 306 may include random access memory (RAM), read only memory (ROM), flash RAM, and/or other types. The memory 306 may store computer-readable, computer-executable software/firmware code including instructions that, when executed, cause the controller 304 to perform various functions described in this disclosure (e.g., configure and disseminate one or more messages based on various safety data, etc.). Alternatively, the software/firmware code may not be directly executable by the controller 304 but may cause a computer (e.g., when compiled and executed) to perform functions described herein. Alternatively, the computer-readable, computer-executable software/firmware code may not be directly executable by the controller 304 but may be configured to cause a computer (e.g., when compiled and executed) to perform functions described herein. The controller 304 may include an intelligent hardware device, e.g., a central processing unit (CPU), a processor, an application-specific integrated circuit (ASIC), etc.

In some embodiments, the memory 306 can contain, among other things, the Basic Input-Output system (BIOS) which may control basic hardware and/or software operation such as the interaction with peripheral components or devices. For example, the communication module 314 to implement the present systems and methods may be stored within the system memory 306. Applications resident with transmitter 200 are generally stored on and accessed via a non-transitory computer readable medium, such as a hard disk drive, flash RAM, or other storage medium. Additionally, applications can be in the form of electronic signals modulated in accordance with the application and data communication technology.

The controller 304 may be coupled to the modulator 308. The modulator 308 may perform modulation. Modulation may comprise a process of varying one or more properties of a periodic waveform. The periodic waveform may comprise a signal. The signal may be a low to medium frequency signal. The signal may contain information to be transmitted to various personnel. The modulator 308 may transfer the signal to the amplifier 310.

The amplifier 310 may increase the power of the signal. For example, the amplifier 310 may connect to a power source 316 to increase the amplitude of a signal. The amplifier 310 may couple to the output coupler 311. The output coupler 311 may couple to the conductor 312. The output coupler 311 couples the signal to some conductor that enters into and extends within the underground or otherwise enclosed space. The output coupler 311 may be a magnetic antenna. The output coupler 311 may be an inductive clamp. The output coupler 311 may be a galvanic electrical connection. The type of output coupler 311 may be selected to transfer an optimal signal onto the conductor 312. The selected output coupler 311 may be configured to predominantly produce a monofilar mode on the conductor 312. The selected output coupler 311 may be configured to predominantly produce a bifilar mode on the conductor 312. The configuration of the selected output coupler 311 may be chosen to transfer an optimal signal onto the conductor 312. The conductor 312 may act as an antenna and may propagate a signal throughout the underground environment. The conductor 312 may comprise a wire or other elongated metallic member that may be set up in the passageways. The conductor 312 may emanate a magnetic field that is received by receivers 202 in proximity or range. In another embodiment, the conductor 312 may emanate a magnetic field that induces a corresponding signal on other conductors 206 in proximity. The other conductors 206 may emanate a magnetic field that is received by receivers 202 in proximity. The other conductors 206 may emanate a magnetic field that induces a corresponding signal on yet other conductors 206 in proximity.

In some embodiments, the frequency of the signal may be in the low to medium frequency range. A low frequency signal typically is in the range of about 30 kHz to about 300 kHz. A medium frequency signal is typically in the range of about 300 kHz to about 3 MHz. The frequency range for the signals transmitted through underground environments according to the present disclosure typically is in the range of about 200 kHz to about 500 kHz, and particular embodiments may use a carrier frequency of 300 kHz. Utilizing such a low to medium frequency bandwidth permits transmission and receipt of messages with sufficient fidelity and bitrate throughout the underground environment and enable delivery of communications a significant distance from the transmitter 200.

The communication module 314 may receive, configure, and transmit messages. For example, the communication module 314 may receive one or more inputs to configure a message to disseminate. The inputs may be a result of one or more inputs from the input unit 302. In some embodiments, the inputs may be automated as discussed previously. In alternative or additional embodiments, the inputs may be manually input. The communication module 314 may then configure the message based on the one or more inputs received. Once the message is configured, the communication module 314 may then transmit one or more messages via the transmitter 200. The communication module 314 may be configured to repeat the transmitted message indefinitely until a different input is received. This message repetition may increase likelihood of reception by receivers 202.

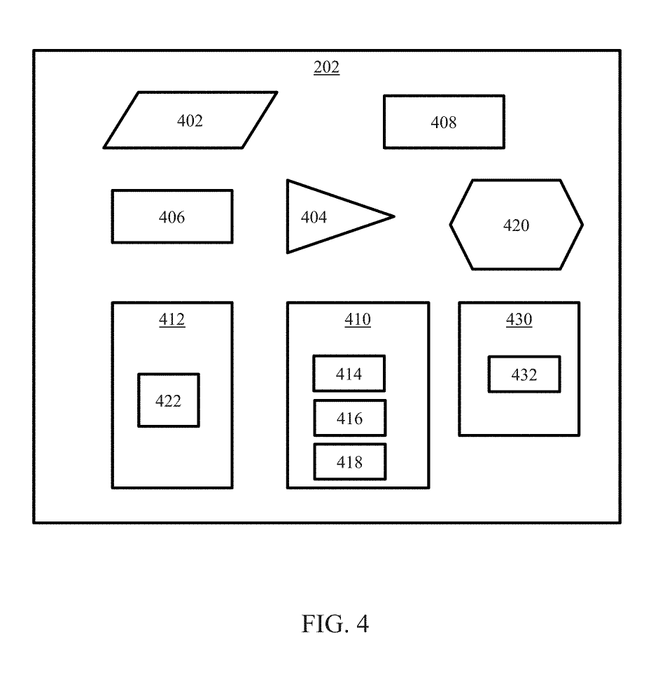

FIG. 4 is a block diagram of the receiver 202. The receiver 202 may comprise an antenna 402, amplifier 404, demodulator 406, controller 408, display module 410, and memory 412. In some embodiments, the receiver 202 may comprise additional or fewer components. In still further embodiments, the display module 410 may include a visual display module 414, an auditory display module 416, and a haptic display module. The receiver 202 may include one or more power sources 420. In some embodiments, the memory 412 may include one or more receiver module 422. Each of these components may be in communication with each other-directly and/or indirectly.

In some embodiments, the antenna 402, amplifier 404, demodulator 406, controller 408, display module 410, and memory 412, each may communicate—directly or indirectly—with one another (e.g., via one or more buses, not shown). The antenna 402 may receive one or more signals. The amplifier 404 may increase the amplitude of these signals and send the amplified signals to the demodulator 406. The demodulator 406 may demodulate signal packets and provide the demodulated packets to the controller 408 for interpretation.

In some embodiments, an antenna 402 may comprise a magnetic antenna. In other embodiments, the antenna 402 may comprise an inductive loop. In other embodiments, the antenna 402 may comprise a galvanic electrical connection. The selection of the antenna 402 in a given embodiment may depend on requirements for portability, survivability, or other characteristics. The antenna 402 may comprise a highly resonant receiving antenna. The antenna 402 may be a transformer which may incorporate dual windings of a magnetic wire. For example, the antenna 402 may be a ferrite antenna and incorporate a primary and secondary winding or wrapping of wire. The first winding of the antenna 402 may comprise a resonant winding. The second winding may feed the amplifier. The antenna 402 may be capable of receiving low to medium frequency signals. The antenna 402 may enable the receiver 202 to detect low to medium frequencies.

In some embodiments, an element of the receiver 202 may additionally connect to the Internet via a POP (point of presence). In some embodiments, one element of receiver 202 may provide a connection using wireless techniques, including digital cellular telephone connection, Cellular Digital Packet Data (CDPD) connection, digital satellite data connection, and/or another connection.

The amplifier 404 may amplify one or more signals detected by the antenna 402. For example, the antenna 402 may detect one or more low amplitude signals. The amplifier 404 may increase the signal such that the signal can be more easily interpreted. Once the signal is amplified, the signal may be transferred to the demodulator 406.

The demodulator 406 may perform demodulation. For example, the demodulator 406 may recover the information content from the modulated carrier wave. The demodulator 406 may then transfer the signal to the controller 408.

The controller 408 may comprise a chip, expansion card, or stand-alone device. The controller 408 may interface with a peripheral device. For example, the controller 408 may link two various parts of the receiver 202. In some instances, the controller 408 may be a microcontroller. In some embodiments, the controller 408 may comprise a processor and/or microprocessor. In some embodiments, the demodulator 406 may be located within the processor. In other embodiments, the demodulator 406 may be separate from the controller 408 but may connect to the controller 408 via one or more buses. The controller 408 may connect to memory 412.

The memory 412 may include random access memory (RAM), read only memory (ROM), flash RAM, and/or other types. The memory 412 may store computer-readable, computer-executable software/firmware code including instructions that, when executed, cause the controller 408 to perform various functions described in this disclosure (e.g., interpret one or more messages and take one or more actions based on the received signal, etc.). Alternatively, the software/firmware code may not be directly executable by the controller 408 but may cause a computer (e.g., when compiled and executed) to perform functions described herein. Alternatively, the computer-readable, computer-executable software/firmware code may not be directly executable by the controller 408 but may be configured to cause a computer (e.g., when compiled and executed) to perform functions described herein. The controller 408 may include an intelligent hardware device, e.g., a central processing unit (CPU), a processor, an application-specific integrated circuit (ASIC), etc.

In some embodiments, the memory 412 can contain, among other things, the Basic Input-Output system (BIOS) which may control basic hardware and/or software operation such as the interaction with peripheral components or devices. For example, the receiver module 422 to implement the present systems and methods may be stored within the system memory 412. Applications resident within the receiver 202 are generally stored on and accessed via a non-transitory computer readable medium, such as a hard disk drive, flash RAM, or other storage medium. Additionally, applications can be in the form of electronic signals modulated in accordance with the application and data communication technology.

The controller 408 may connect to the memory 412 which may store the receiver module 422. The receiver module 422 may interpret received transmissions to determine if one or more messages communicate taking a predetermined action. For example, the receiver module 422 may interpret the various data bytes transferred via the low to medium frequency signal. In some embodiments, the signal may communicate one or more codes. The codes may correlate to one or more predetermined actions stored within the memory 412. In other embodiments, the signal may communicate the message directly without the need to program the receiver 202 with messages prior to dissemination.

The receiver module 422 may then determine one or more display feedbacks to the display module 410. The display module 410 may be connected to the visual display module 414, the auditory display module 416, and/or a haptic display module 418. The receiver module 422 may interpret the received signal and communicate to the display module 410 which display is necessary to communicate the message.

In some embodiments, the display module 410 may result in a message being displayed via text on the receiver 202. For example, the visual display module 414 may be connected to one or more displays on the receiver 202. The visual display module 414 may additionally or alternatively incorporate a light display. For example, the visual display module 414 may couple to an LED which may flash when a message in received and being communicated. In some embodiments, the length and duration of the light display may communicate the message to the user.

In other embodiments, the display module 410 may result in one or more of the visual display module 414, auditory display module 416, and or the haptic display module 418 to activate. Each of the modules 414, 416, 418 may react differently to each of the messages to disseminate. For example, if the display module 410 interprets a message to evacuate the underground environment, each of the modules 414, 416, 418 may take a predetermined action. The length and duration of each modules 414, 416, 418 actions may result in the communication of a message to the user.

In some embodiments, the receiver 202 may include an accessory unit 430. The accessory unit 430 may be, for example, a beacon, tracker, or tracking tag. The accessory unit 430 may be in communication with the controller 408 and/or other components of the receiver 202. The accessory unit 430 may provide additional transmitting or receiving functionality. For example, the accessory unit 430 may provide the added functionality of a tracking beacon or receiver functionality. The accessory unit 430 may implement tracking functions using, for example, radio frequency identification (RFID) technology. The accessory unit 430 may interface with, or rely upon, neighboring conductors (e.g., neighboring conductors 206, see FIG. 2) to emanate a signal as described with reference to FIG. 2. In other embodiments, additional wiring for RF signals may be installed in the underground environment. The additional devices and wiring along with the accessory unit 430 may form or create a location tracking system. This location tracking system may utilize, for example, medium frequency signaling or conventional wired or wireless signaling to communicate tracking and/or other information. This information may originate from, or be relayed to, personnel or equipment at the surface (e.g., above ground) or some other location when the accessory unit 430 is positioned below ground.

In some embodiments, the accessory unit 430 may include a transmitter 432. Signals transmitted by the transmitter 432 may be received by the neighboring conductors 206 or electrical devices 114 in the underground space or an enclosed space. The accessory unit 430 may transmit a unique identifier such as a serial number for each receiver 202. The accessory unit 430 may also transmit a status. For example, the receiver 202 may receive various signals through the antenna 402, amplifier 404, demodulator 406, and/or controller 408. The status may include, for example, a location of the receiver 202, a health of the individual with the receiver 202, and/or a condition of the environment surrounding the receiver 202. For example, the status may include an oxygen level, carbon monoxide level, or other information associated with the environment. The signals received by the electrical devices 114 may be relayed to the surface or other location by, for example, medium frequency signals or other wired or wireless means.

In some embodiments, the accessory unit 430 may include reception of short-ranged RFID data transmitted by the electrical equipment 114. The accessory unit 430 may receive, for example, serial number data from pre-placed RFID or other beacons. The controller 408 may use the serial number data to display alerts to the user. For example, distinct RFID beacons with unique data transmissions may be placed in different partitions of the underground or enclosed space. A message from the transmitter 200 may signify an emergency situation in one or more specific partitions. The receiver 202 may utilize the reception of localized RFID data from the nearest beacon to determine if the user is present in one of the partitions affected by the emergency situation, and display the appropriate alert accordingly. For example, receivers 202 in one partition may signal to evacuate, whereas receivers 202 in another partition may signal to take shelter in place, and receivers 202 in yet another partition may safely disregard the particular emergency alert because they are located in an unaffected area.

In some embodiments, the neighboring conductors interfaced by the accessory unit 430 may be hardened and survivable for post-incident use. In other embodiments, the neighboring conductors or electrical devices interfaced by the accessory unit 430 may be ordinary composition and construction, and may not be relied upon to be present and functional after an emergency incident. In such cases, the logic and operations executed by the controller 408 and surface operations may be designed to use the most recent accessory transmissions and receptions to establish a last known location and act accordingly.

Integrating the accessory unit 430 into the receiver 202 may provide advantages as compared to providing the accessory unit 430 as a separate device from the receiver 202. For example, by integrating the accessory unit 430 into the receiver 202, the features, components and functionality of the accessory unit 430 may be integrated and optimized with remaining features, components and functionality of the receiver 202. Further, trackers carried by personnel in underground and other enclosed spaces typically require a separate housing, power source, and communication system from the receiver 202, thus requiring additional cost, space, time and related expenses, which can be substantially eliminated by integrating accessory unit 430 into the receiver 202 as shown in FIG. 4 and described herein.

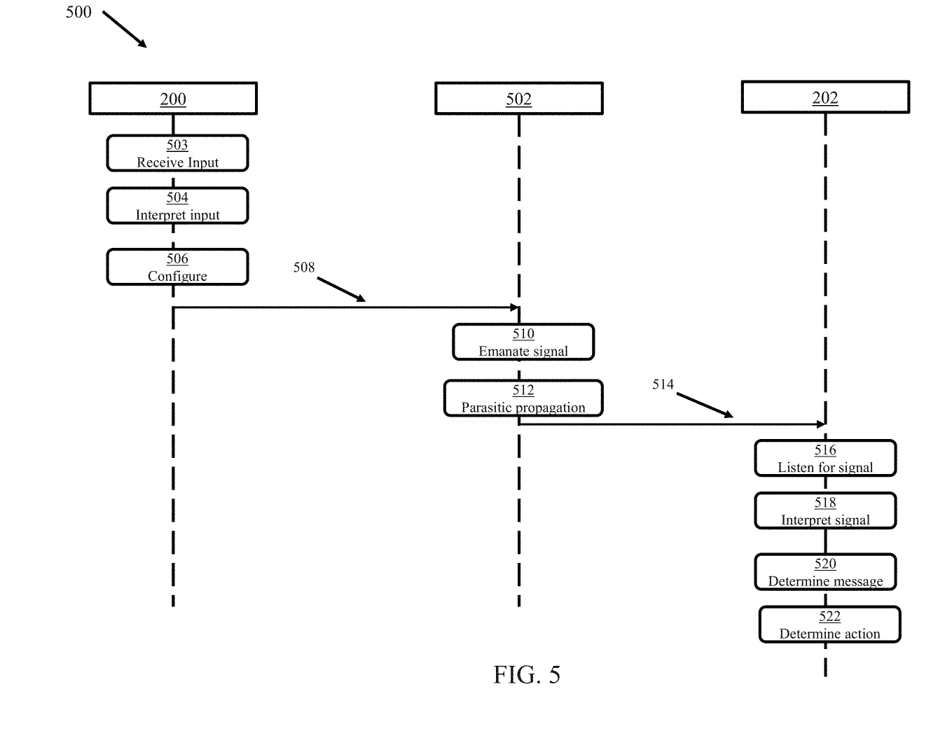

FIG. 5 is a flow diagram of a remote alert system 500. The remote alert system 500 may include a transmitter 200, conductor 502, and a plurality of receivers 202. The transmitter 200 may be one or more examples of the transmitter 200 described with reference to FIGS. 2 and 3. The receiver 202 may be one or more examples of a receiver 202 described with referenced to FIGS. 2 and 4. The conductor 502 may be one example of the input conductor 204 and/or the neighboring conductors 206 described with reference to FIG. 2.

In some embodiments, the transmitter 200 may receive one or more inputs 503 of a safety situation in an underground environment. The inputs may comprise a plurality of conditions. For example, the inputs may comprise one of a safety condition of the underground environment or a safety response for personnel. For example, in some embodiments, a user may input an event at an underground environment that may require a safety response. The input may be one of a condition detected such as an explosion, fire, gas leak, flood, or the like. The transmitter 200 may be programmed to interpret the safety condition and the location of the condition 504 to configure one or more messages 506 to transmit to a plurality of receivers.

The transmitter 200 may then transfer 508 the message to one or more conductors 502. The conductors 502 may emanate the signal. In some embodiments, an initial conductor 502 may emanate the signal 510 into one or more passageways. The signal may then parasitically propagate 512 throughout the entirety of the underground environment where signal carrying conductive structures and/or materials are present. For example, the signal may emanate from an initial conductor 502 which may then be picked up and transmitted by one or more secondary conductors 502.

The conductors 502 may propagate a magnetic signal 514 throughout the underground environment that may be picked up by one or more receivers 202. The conductors 502 may emanate magnetic fields which induce a corresponding signal onto other conductors 502. The receivers 202 may selectively listen 516 for one or more low to medium frequency signals and interpret the signals 518 to determine a message 520.

Depending upon the message received, the receiver 202 may perform a plurality of predetermined actions 522. For example, if the message is an “all okay” message, the receiver 202 may simply trigger one or more of the display modules to communicate a working connection. In some embodiments, if the message is a safety message, the receiver 202 may take more active reactions to communicate a safety event. The reaction may comprise activating at least one of a visual display, an auditory display, and a tactile response. For example, the receiver 202 may be preprogrammed with text messages to display to the user. In other embodiments, the receiver 202 may activate all of the displays to communicate a safety event. For example, the combination, duration, and length of each response may communicate an event to the user, much like Morse code.

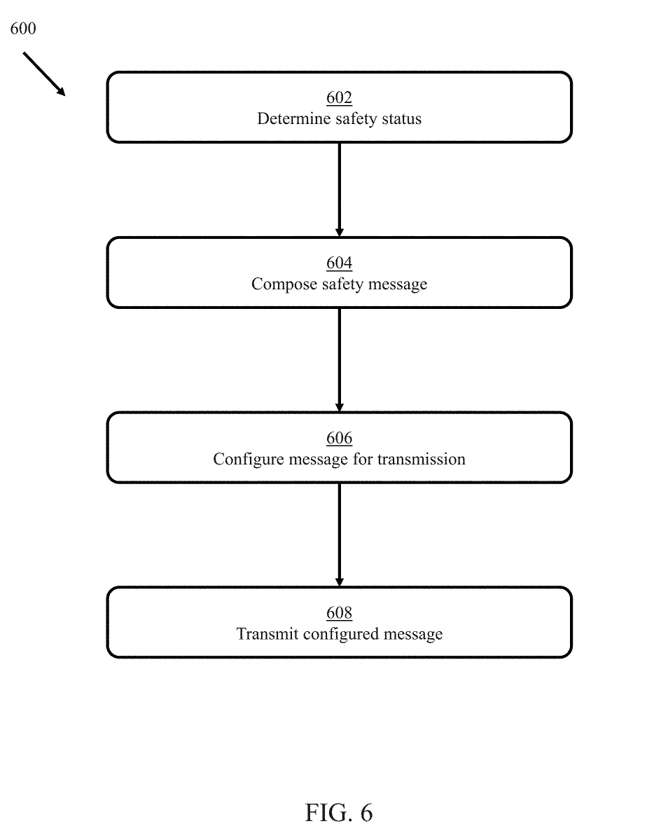

FIG. 6 is a flow chart illustrating an example of a method 600 for remote alert systems, in accordance with various aspects of the present disclosure. For clarity, the method 600 is described below with reference to aspects of one or more of the transmitter 200 described with reference to FIGS. 2, 3 and 5, and/or aspects of one or more of the communication module 314 described with reference to FIG. 3. In some examples, the transmitter may execute one or more sets of codes to control the functional elements of the communication module 314 to perform the functions described below. Additionally or alternatively, the transmitter may perform one or more of the functions described below using special-purpose hardware.

At block 602, the method 600 may include determining a safety status. The safety status may comprise a safety status of the entirety of an underground environment (e.g. underground environment 100). In further embodiments, the underground environment may be segmented into different segments and each segment may have an associated safety status. The safety status may comprise a rating system. For example, the safety status may comprise a “green setting” for an all safe message. The rating system may advance through a series of ratings coordinating with relative safety concerns.

In another embodiment, the safety status may coordinate to an action. For example, accidents and events at underground environments can be unpredictable. While there may be a list of known events that may occur, there is a possibility of an unforeseen risk that occurs. To prevent a lack of communication, the safety status may instead correlate to actions to be taken by personnel. For example, a normal safety setting with no events may result in a “continue work as normal” message. If an accident occurs that is localized, for example a derailing of equipment or an accident such as a personnel fall or injury, the message may result in a “stay in location” message. This may convey that an overarching safety hazard is not present but personnel are to stay in their present locations to prevent interference with emergency personnel working to repair or care for the localized event.

The safety settings may escalate as the safety events become more hazard. For example, messaging may indicate when to don safety equipment, when to evacuate an underground environment, when to find a reinforced room to shelter in place, and the like. Each underground environment is subject to various environmental and localized hazards. Therefore, the messaging system and safety settings presented herein are exemplary only. The message and specific settings may be customized for each specific location depending upon known and predicted hazards.

In some embodiments, the safety status may be a result of a manual input. For example, various personnel may manually enter either an event that has occurred or an action that needs to be taken. This may be done directly at the transmitter using various inputs (e.g. input unit 302). In some embodiments, various other personnel may use one or more devices to communicate with the transmitter to distribute a message. For example, personnel such as managers or overseers may be equipped with mobile devices which may remotely communicate safety events to the transmitter. In some embodiments, various segments or partitions of the underground environment may be equipped with a computing device which may communicate with the transmitter or other personnel with access to the transmitter.

In still further embodiments, the safety status may be automated. For example, the transmitter may automatically detect the presence of a safety event through one or more sensors or other data gathering devices. The transmitter may then analyze the incoming data to determine the presence of a safety event. Once the safety status is determined, the transmitter may automatically select the safety message to disseminate.

In still further embodiments, various aspects of the safety status may be a combination of automated and manual inputs. For example, in some instances, the entirety of a change in safety status may be a result of a manual input in both the safety event and the message to be conveyed. In further embodiments, personnel may manually enter an event and location into the transmitter which may then automatically determine which actions should be taken.

At block 602, the method 600 may include composing the safety message. In some embodiments, composing the safety message may result in a series of statuses as discussed. For example, the message may include a communication of the event that occur and an action to take. In some embodiments, the message may include either/or. For example, the message may either indicate the safety event or may communicate actions to be taken. The message may be composed in various languages and may be generalized or customized to each location in the underground environment. For example, coal mines may have a different set of dangers present than an ore mine. The location of the underground environment may also result in varying message. For example, an underground environment may be located near a large body of water, an active fault line, or other geographical concerns. Additionally, underground environments may be located in various regions with conflict. Therefore, the safety events and resulting communications may be customized as required, wanted, or desired.

At block 604, the method 600 may include configuring the message. For example, depending upon the communication system being used to transmit the message may affect how the message is configured. In some embodiments, the message may be coded. For example, the transmitter and receiver may each be programmed with predetermined codes which may correlate to predetermined messages. Therefore, the transmitter may determine the appropriate communication and then code the message for communication to the receiver. If a low to medium frequency signal is used, the coding will enable thorough messages to be disseminated in a timely manner. For example, some embodiments of low to medium frequency carrier waves with low fixed deviation modulation may transmit 10-100 bits per second. Therefore, more complex messages may result in a longer than desired transmission time. To optimize the transmission time of the message, the message may be significantly shortened using code.

At block 608, the method 600 may include transmitting the configured communication. For example, once the message is coded, the transmitter may then disseminate the message. In some embodiments, the communication may be disseminated by a conductor. The conductor may comprise a wire or other elongated metal object which be easily inserted into and installed in the underground environment. The conductor may act as an antenna and may disseminate a signal. The signal may be a low to medium frequency signal. The signal may then advance throughout the underground environment using parasitic propagation. Parasitic propagation may involve emanated magnetic fields enveloping other conductors in proximity and inducing corresponding electrical currents in those conductors. The frequency of the signal coupled with parasitic propagation may result in the signal being transmitted long distances and throughout most, if not all, of the passageways present in the underground environment. Additionally, by being able to insert the antenna into the underground environment, it prevents an expanding antenna on the surface. Additionally, the antenna follows the existing geometry and topology of the mine or other underground environment and does not need to be specialized geometry such as a tuned resonant loop.

In some embodiments, the communication may be directed to a specific sub-group of receivers. For example, each personnel with a receiver may be a predetermined group or category. There may be multiple groups or categories distinguished by different configurations in the memory or the receiver module. This distinction may be according to job function or location within the underground environment or other applicable subdivision of personnel. The method 600 may transmit the message to only a specific subgroup based on the safety event. For example, if a safety drill is being run, the personnel may only wish to test the system on a subgroup rather than notifying an entire underground environment. In another embodiment, only a specific subgroup of personnel may be endangered by the safety event. This may create targeted messages to be disseminated to specific subgroups. For example, upon receiving a targeted message, a specific targeted subgroup of receivers may activate alert displays based on distinct contents of memory, while another untargeted subgroup of receivers with different content in memory may receive the same signal and not activate alert displays.

Thus, the method 600 may provide for remote alert systems relating to confined underground systems. It should be noted that the method 600 is just one implementation and that the operations of the method 600 may be rearranged or otherwise modified such that other implementations are possible.

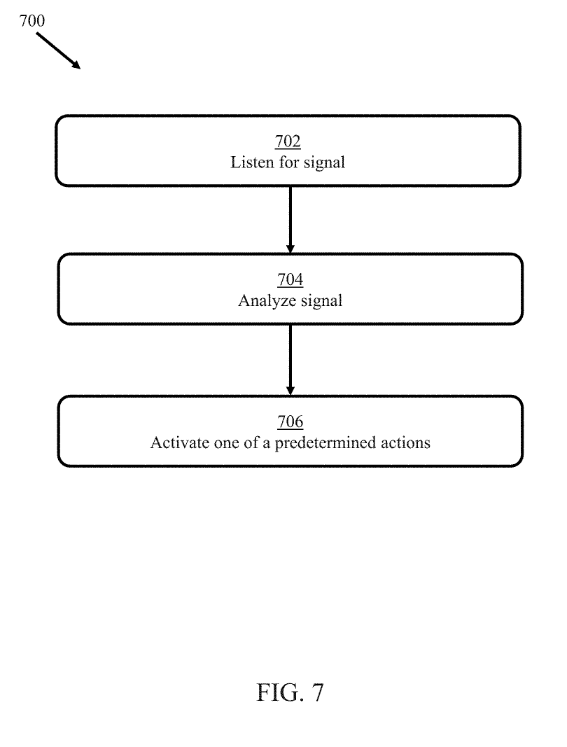

FIG. 7 is a flow chart illustrating an example of a method 700 for remote alert systems, in accordance with various aspects of the present disclosure. For clarity, the method 700 is described below with reference to aspects of one or more of the receiver 202 described with reference to FIGS. 2, 4, and 5, and/or aspects of one or more of the receiver module 422 described with reference to FIG. 4. In some examples, the receiver 202 may execute one or more sets of codes to control the functional elements of the receiver module 422 to perform the functions described below. Additionally or alternatively, the receiver 202 may perform one or more of the functions described below using special-purpose hardware.

At block 702, the method 700 may include listening for a signal. For example, the receiver may be equipped with an antenna. The antenna may pick up a variety of frequency signals present in its environment. At block 704, the method 700 may include analyzing the signal. For example, multiple signals may be present in the environment. However, the receiver may analyze the signals to determine whether the received signals are at a frequency or in a particular format to be interpreted by the receiver. This may include parsing the various signals. Once the signals have been parsed, the receiver may interpret the signals to determine if a safety message has been conveyed.

At block 706, the method 700 may include taking a predetermined action. The predetermined action may be based on the communication signal. The predetermined action may communicate the message to a user or wearer of a receiver. The predetermined action may activate a series of outputs from the receiver to alert the user of an incoming message. For example, the receiver may activate a haptic response, a visual response, and/or an auditory response. In some embodiments, the receiver various outputs may convey a message to the user. For example, a combination of outputs or a length and duration of various outputs may act as a messaging system and alert a user of specific actions. For example, if personnel need to evacuate, all three outputs may activate. If there is no active alert, the receiver may blink to communicate a “green” or all safe communication. In some embodiments, this may also communicate that the receiver is still active and receiving transmissions. In some embodiments, the receiver may continue to output the message until a new safety status is distributed. In other embodiments, the receiver may only output a message for a predetermined time period and then display the next output when the next incoming transmission is received and analyzed.

Thus, the method 700 may provide for remote alert systems relating to confined underground systems. It should be noted that the method 700 is just one implementation and that the operations of the method 700 may be rearranged or otherwise modified such that other implementations are possible.

For example, in some embodiments related to the method 700, the communication may be directed to a specific sub-group of receivers. There may be multiple groups or categories distinguished by different configurations in the memory or the receiver module. This distinction may be according to job function or location within the underground environment or other applicable subdivision of personnel. The method 700 may transmit the message to only a specific subgroup based on the safety event. In another embodiment, only a specific subgroup of personnel may be endangered by the safety event. This may create targeted messages to be disseminated to specific subgroups. For example, upon receiving a targeted message, a specific targeted subgroup of receivers may activate alert displays based on distinct contents of memory while another untargeted subgroup of receivers with different content in memory may receive the same signal and not activate alert displays.

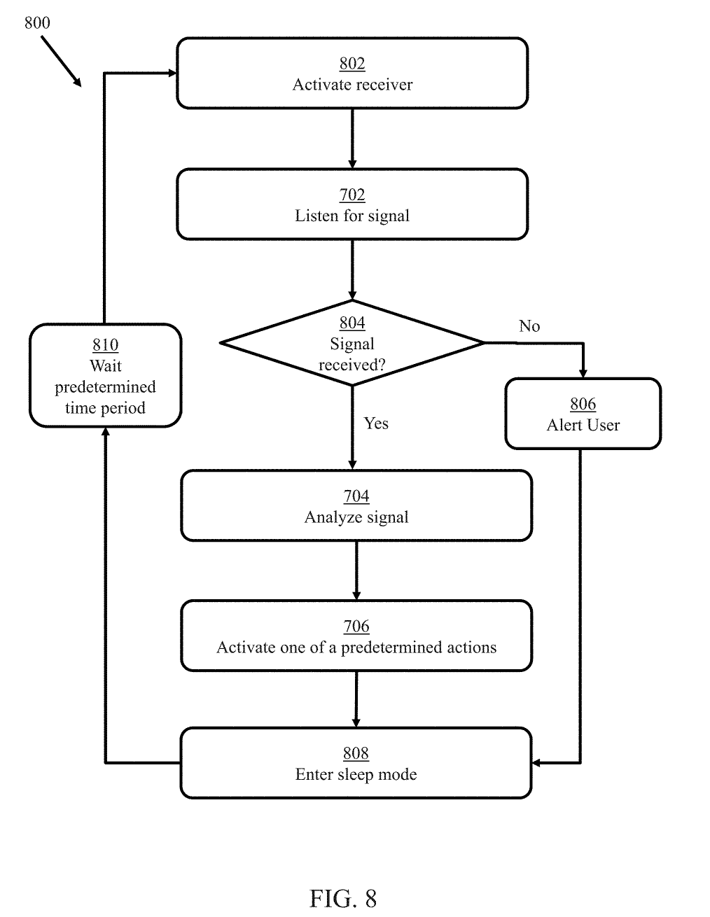

FIG. 8 is a flow chart illustrating an example of a method 800 for remote alert systems, in accordance with various aspects of the present disclosure. For clarity, the method 800 is described below with reference to aspects of one or more of the receiver 202 described with reference to FIGS. 2, 4, and 5, and/or aspects of one or more of the receiver module 422 described with reference to FIG. 4. In some examples, the receiver may execute one or more sets of codes to control the functional elements of the receiver module to perform the functions described below. Additionally or alternatively, the receiver may perform one or more of the functions described below using special-purpose hardware.

At block 802, the method 800 may include activating the receiver. For example, the receiver may need to be activated for the day. Perhaps the receiver was charging or otherwise not in use. In another embodiment, the receiver may be a rest or sleep state. For example, the receiver may have been powered on but may not have been activated and functioning. Rather, the receiver may have been waiting for one or more timers, inputs, or codes to turn on and begin to function.

At block 702, the method 800 may listen for a signal as described with reference to FIG. 7. At block 804 the method may determine if a signal is received. If a signal is not received, the method 800 may continue to block 806. For example, at block 806, if no signal is received, the method 800 may alert the user that a signal was not received. The signal could not be received for a multitude of reasons. The receiver may be out of signal range and may be unable to detect a signal. The receiver may be faulty and may not be receiving a signal; the received signal may not correlate to any preprogrammed messages. Once the receiver alerts the user of a lack of signal, the method 800 may enter a sleep mode (e.g., sleep mode 808, described below). Alternatively, the method 800 may continue from block 806 to listen for a signal at block 702.

If a signal is received, at block 704, the method 800 may analyze the signal and, at block 706, the method 800 may activate or take one of a predetermined action based on the analyzed signal as described with reference to FIG. 7.

At block 808, the method 800 may then cause the receiver to enter a sleep mode. For example, to conserve battery life or power, the receiver may enter a sleep mode for a predetermined period of time. At block 810, the method 800 may include waiting a predetermined time period prior to restarting the method at block 802. The predetermined time period may comprise a few milliseconds, a few seconds, a minute, a few minutes, and so forth. The predetermined time period should be programmed considering the safety hazards that could potentially be present. For example, if asphyxiation is a concern, the predetermined time period should factor in a typical time for people to become unresponsive.

The predetermined time period is variable and in some instances, can be eliminated. For example, in some embodiments the method 800 may continuously look from activating a predetermined action at block 706 to then listening for a signal at block 702. In alternative embodiments, the method 800 may be able to vary the predetermined time period. For example, a normal setting may set the receiver to sleep for approximately 5-10 seconds or longer (e.g., in an effort to conserve battery life). If an emergency situation arises, the method 800 may eliminate the sleep mode and continuously run the receiver to actively receive messages.

Thus, the method 800 may provide for remote alert systems relating to confined underground systems. It should be noted that the method 800 is just one implementation and that the operations of the method 800 may be rearranged or otherwise modified such that other implementations are possible.

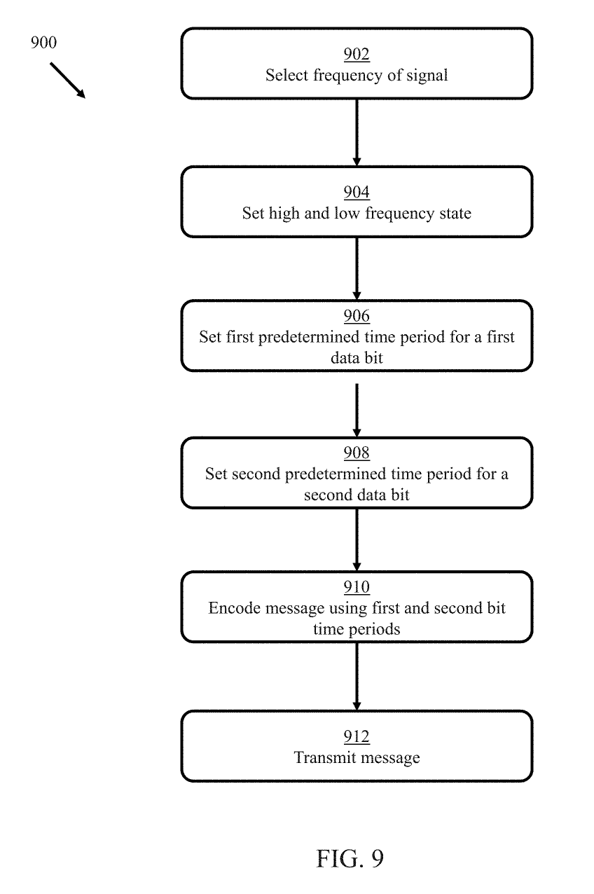

FIG. 9 is a flow chart illustrating an example of a method 900 for remote alert systems, in accordance with various aspects of the present disclosure. For clarity, the method 900 is described below with reference to aspects of one or more of the transmitter 200 and/or receiver 202 described with reference to FIGS. 2-5, and/or aspects of one or more of the communication module 314 and/or receiver module 422 described with reference to FIGS. 3-4. In some examples, the transmitter and/or receiver may execute one or more sets of codes to control the functional elements of the communication module and/or receiver module to perform the functions described below. Additionally or alternatively, the transmitter and/or the receiver may perform one or more of the functions described below using special-purpose hardware.

At block 902, the method 900 may include selecting a frequency for communication transmissions. The frequency may be a low to medium frequency signal. In some embodiments, the selected frequency may consist of a range of frequencies. In other embodiments, the frequency may be a specific frequency with a margin of error.

At block 904, the method 900 may include setting a high and low frequency state of the selected frequency. The low state may be a little lower than the selected frequency. The high state may be a little higher than the selected frequency.

At block 906, the method 900 may include setting a first predetermined time period correlating to a first data bit. The first predetermined time period may comprise a first range of time. For example, the first predetermined time period may be between 5-100 milliseconds. In other embodiments, the first predetermined time period may be a narrower range, for example 15-20 milliseconds. The actual range selected may vary but should be distinct from the second predetermined time period that correlates to the second data bit.

At block 908, the method 900 may include setting a second predetermined time period correlating to a second data bit. The second predetermined time period may comprise a second range of time. For example, the second predetermined time period may be between 30-60 milliseconds. In other embodiments, the second predetermined time period may be a narrower range, for example 30-40 milliseconds. The actual range selected may vary but should be distinct from the first predetermined time period that correlates to the first data bit. This may avoid confusion in interpreting the signals.

At block 910, the method 900 may encode the message using a first and second predetermined time periods. For example, the message may be communicated using a first and second data bit. Depending upon the message to be communicated, the message may correlate to a code that can be transmitted using a sequence of the first and second data bits.

At block 912, the method 900 may transmit the message using the high and low states. For example, the method 900 may transmit a series of first data bits and second data bits suing the high and low states. For example, a first data bit may be transmitted at a low state for a first predetermined period of time. The next data bit may be a first data bit transmitted at a high state for the first predetermined period of time. If the next bit is the second data bit, the second data bit may then be transmitted at the low state for a second predetermined period of time. If the next data bit is again the first data bit, the method 900 may transmit a signal at the high state for the first predetermined period of time.

The actual message will determine which data bits are sent and how. For example, the first data bit may be a 0 and the second data bit may be a 1. If the message is to evacuate, the evacuate code may be 01101. The method 900 may then transmit varying high and low state frequencies at the first and second predetermined time periods to communicate the proper code. If the evacuation code is 01101, then the method 900 may first transmit a low state for the first predetermined time period, then the high state for the second predetermined time period, then the low state for the second predetermined time period, then the high state for the first predetermined time period, and end with the low state for the second predetermined time period. The examples are provided herein to provide clarity and are not inhibiting of the length of codes, and/or duration of the first or second predetermined time period. In some embodiments, longer codes may be selected to encode more possible states. Additionally or alternatively, longer codes may be selected to prevent random noise from being falsely interpreted as messages.

Thus, the method 900 may provide for remote alert systems relating to confined underground systems. It should be noted that the method 900 is just one implementation and that the operations of the method 900 may be rearranged or otherwise modified such that other implementations are possible.

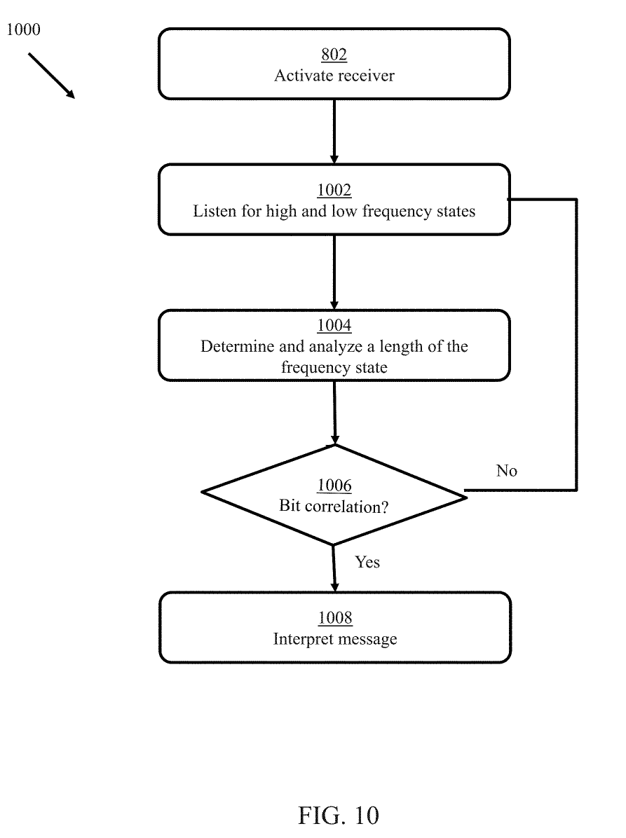

FIG. 10 is a flow chart illustrating an example of a method 1000 for remote alert systems, in accordance with various aspects of the present disclosure. For clarity, the method 1000 is described below with reference to aspects of one or more of the transmitter 200 and/or receiver 202 described with reference to FIGS. 2-5, and/or aspects of one or more of the communication module 314 and/or receiver module 422 described with reference to FIGS. 3-4. In some examples, the transmitter and/or receiver may execute one or more sets of codes to control the functional elements of the communication module and/or receiver module to perform the functions described below. Additionally or alternatively, the transmitter and/or the receiver may perform one or more of the functions described below using special-purpose hardware.

At block 1002, the method 1000 may include listening for high state and low state frequency range. At block 1004, the method 1000 may include determining and analyzing the frequency range and the length of the signal. For example, the method 1000 may be specifically looking for high and low state frequency signals for the first and second predetermined time periods.

At block 1006, the method 1000 may include determining if the length of time at the present frequency of the signal corresponds to a first or second data bit. If the time at the present frequency does correlate, then, at block 1008, the method 1000 may begin interpreting the message. For example the method 1000 may begin analyzing if the frequency signal corresponds to a first data bit or a second data bit and may begin to piece together the code and/or communication.

If, at block 1006, the method 1000 determines the signal does not correspond to a first or second data bit, the method 1000 may restart the process and, at block 1002, begin listening for the high and low state frequency signals. The transmitter may repeat the message code indefinitely and each time the bit pattern is transmitted represents an opportunity to decode it.

Thus, the method 1000 may provide for remote alert systems relating to confined underground systems. It should be noted that the method 1000 is just one implementation and that the operations of the method 1000 may be rearranged or otherwise modified such that other implementations are possible.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. An underground communication system, the system comprising:
a low to medium frequency transmitter, the transmitter comprising:
an output coupler;
a signal selection unit;
wherein the transmitter is operable to generate a low to medium frequency signal;
a plurality of receivers, the plurality of receivers each comprising:
an antenna;
at least one sensory output unit;
wherein the plurality of receivers is configured to detect a low to medium frequency signal.

2. The underground communication system of claim 1, wherein the transmitter further comprises:
an input unit;
a microcontroller;
a modulator;
an amplifier.

3. The underground communication system of claim 1, wherein the transmitter output coupler is one of a magnetic antenna, inductive clamp, or galvanic electrical connection.

4. The underground communication system of claim 1, wherein the wireless receiver antenna further comprises a coil of wire on a ferrite core.

5. The underground communication system of claim 1, wherein the transmitter is configured to send a signal to the at least one wireless receiver, the signal being between 30 kHz to 300 kHz, or between about 300 kHz and about 3 MHz, or between about 30 kHz and about 3 MHz.

6. The underground communication system of claim 5, wherein the transmitter output coupler is configured to be positioned beneath a surface of an earth, and the signal is configured to propagate beneath the surface of the earth through parasitic propagation of man-made metallic items.

7. The underground communication system of claim 6, wherein at least some of the plurality of receivers further comprise an accessory unit, the accessory unit having a transmitter configured to transmit a unique identifier for the receiver.

8. The underground communication system of claim 7, wherein the unique identifier is at least partially determined by an identified signal transmission.

9. The underground communication system of claim 1, wherein the at least one sensory output unit comprises one or more of an audio output, a visual output, or a tactile output.

10. The underground communication system of claim 1, wherein the signal selection unit comprises a manual signal selection unit.

11. The underground communication system of claim 1, wherein the signal selection unit comprises an automatic signal selection unit.

12. A method of electronic communication in an underground environment, the method comprising:
selecting a signal to transmit to at least one receiver located in the underground environment;
transmitting the selected signal as a low to medium frequency signal to of the at least one receiver located in the underground environment, the transmitting including propagating the selected signal through parasitic propagation in man-made metallic items located in the underground environment.

13. The method of claim 12, wherein the at least one receiver includes a plurality of receivers, the method further comprising:
parsing the plurality of receivers into at least two groups of receivers;
selecting a first signal to send to a first of the at least two groups of receivers;
selecting a second signal to send to a second of the at least two groups of receivers;
transmitting the first and second signals as low to medium frequency signals to the first and second groups of receivers.

14. A method for receiving an underground communication, the method comprising:
selectively listening for a signal transmission;
receiving more than one signal transmission;
filtering the signal transmissions;
identifying the appropriate signal transmissions;
deciphering the identified signal transmission;
taking one or more predetermined responses based at least in part on the identified signal transmission.

15. The method of claim 14, further comprising:
activating one or more sensory output units based at least in part on the deciphered signal transmission.

16. The method of claim 14, further comprising:
taking no action based at least in part on the deciphered signal transmission;
resuming selectively listening for a signal transmission.

17. The method of claim 14, wherein the signal is a low to medium frequency signal.

18. The method of claim 14, wherein the predetermined response is a data transmission through an accessory transmitter.

19. A method to reduce noise in data transmission, the method comprising:
receiving one or more signals;
parsing a frequency range of the one or more signals;
determining a time length of the parsed frequency signal;
implementing one or more predetermined actions based at least in part on the frequency range and signal length.

20. The method of claim 19, further comprising:
determining if the signal frequency is a fixed frequency deviation low signal or a fixed frequency deviation high signal.

21. The method of claim 19, further comprising:
setting a first predetermined time period to a first data bit;
assigning the first data bit to a signal in a first signal frequency for a first predetermined time period.

22. The method of claim 21, further comprising:
setting a second predetermined time period to a second data bit;
assigning the second data bit to a signal in a first signal frequency for a first predetermined time period.
